(19) United States
(12) Patent Application Publication
(10) Pub. No.: US 2002/0188437 A1
(43) Pub. Date: Dec. 12, 2002

(54) Method for setting of handset type computers and handset interfaces

(76) Inventor: Ching-Hsiu Chou, Taipei Hsien (TW)

Correspondence Address: BACON & THOMAS, PLLC, 4th Floor, 625 Slaters Lane, Alexandria, VA, 22314-1176, US

(21) Appl. No.: 09/837,463

(22) Filed: Apr. 19, 2001

(51) Int. Cl. G06F 17/20

(52) U.S. Cl. 704/2

(57) ABSTRACT

A method for the setting of handset type computers and handset interfaces is disclosed, wherein four special function keys [GA, G5, G6, OK] and [← ↑ ↓ → + − =] are used in the setting interface of various languages. The interface is used in various handsets so that the handset has the function of text processing. The setting interface is built in a chipset and then the chipset is installed in a handset.

### FIELD OF THE INVENTION

The present invention relates to a setting of handset type computers and handset interfaces, wherein four special function keys [GA, G5, G6, OK] and [← ↑ ↓ → + − =] are used, people all over the world can use the present invention to process texts of various languages.

### BACKGROUND OF THE INVENTION

The current commercial WAP handsets with the function of network connection have built with a native language and English so that the user may input data for information transmission. However, various languages are used all over the world, and thus, the handsets must be matched with various languages desired for conforming the requirement of the users. Moreover, although some handsets have the ability of text compiling, the functions thereof are too simple and the operations are too hard. Therefore, the prior art handset interfaces have many defects which are necessary to be improved.

### SUMMARY OF THE INVENTION

Accordingly, the primary object of the present invention is to provide a setting of handset type computers and handset interfaces, wherein four special function keys [GA, G5, G6, OK] and [← ↑ ↓ → + − =] are used, and thus, people all over the world can use the present invention to process texts of various languages.

Another object of the present invention is to provide a setting of handset type computers and handset interfaces, wherein all settings about various nations are embodied in a chipset so as to be updated according to the language of the used text.

A further object of the present invention is to provide a setting of handset type computers and handset interfaces, wherein the setting of handset type computers and handset interfaces of the present invention has the function of e-mail, exchange rate conversion, calculator, translation, multimedia, receiving network program, etc.

A yet object of the present invention is to provide a setting of handset type computers and handset interfaces, wherein the handset code technology is used so that complex and simple form Chinese are used. No repeated code occurs.

To achieve the aforesaid objects. The present invention provides a method for the setting of handset type computers and handset interfaces, wherein four special function keys [GA, G5, G6, OK] and [← ↑ ↓ → + − =] are used in the setting interface of various languages, the interface is used in various handsets so that the handset has the function of text processing. The setting interface is built in a chipset and then the chipset is installed in a handset. At most five codes are used in single Chinese character input for the handset number, all no [repeated code]. At most five codes is used in a multiple Chinese character input for the handset number, all no [repeated code], in which six keys for a phrase forming by two words; six keys for a phrase forming by three words; eight keys for a phrase forming by four words; ten keys for a phrase forming by five words, etc.

The various objects and advantages of the present invention will be more readily understood from the following detailed description when read in conjunction with the appended drawing.

### BRIEF DESCRIPTION OF THE DRAWINGS

FIG. 1 is a schematic view showing the key distribution of the setting of handset type computers and handset interfaces according to the present invention.

FIG. 2 is a schematic view showing an embodiment (1) that the present invention is used with a handset.

FIG. 3 is a schematic view showing an embodiment (2) that the present invention is used with a handset.

### DETAILED DESCRIPTION OF THE PREFERRED EMBODIMENTS

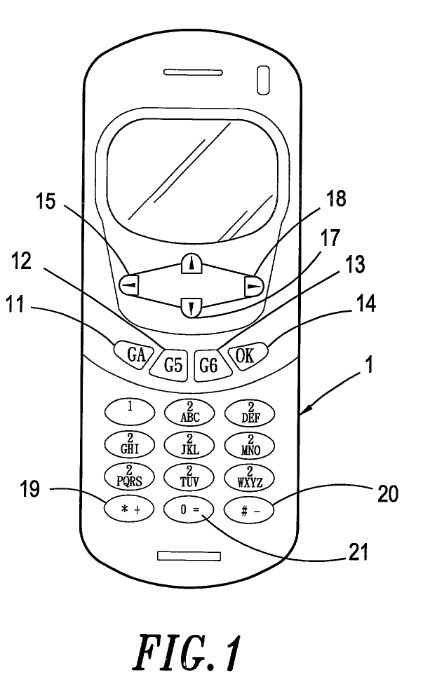

Referring to FIG. 1, a schematic view about the handset key distribution of the setting of the handset type computer and handset interface. In the drawing, four special function keys [GA, G5, G6, OK] (11, 12, 13, 14) and [← ↑ ↓ → + − =] (15, 16, 17, 18, 19, 20, 21) are used in the setting of handset type computers and handset interfaces of the present invention. These keys and the original keys are matched to the handset panel 1 and have the following function.

1. The use of the function keys and the operation ways.

1) GA function key

(1) GA=space bar key.

(2) GA+←=from Home jumps to leftmost;

GA+→=from Home jumps to rightmost;

GA+↑=from Page Up jumps to uppermost;

GA+↓=from Page Down jumps to lowermost.

(3) GA+↑+↑=from Ctrl Page Up to front most;

GA+↓+↓=from Ctrl END to rear most.

(4) GA+GA=move to;

GA+GA+1=move to page 1;

GA+GA+2=move to page 2;

GA+GA+3=move to page 3;

GA+GA+GA=all move to.

(5) GA+G5+↑=writing longitudinally;

GA+G5+←=writing transversally from left to right;

GA+G5+→=writing transversally from right to left.

(6) GA+OK=E-mail box;

(7) GA+G6=compiling the listing order;

(8) GA+*=Page Up

(9) GA+#=Page down

1) G5 functional key:

(1) G5=Enter key

(2) G5+←=delete one word at left side;

GA+→=delete one word at right side;

G5+←+←=delete all words at left side;

GA+→+→=delete all words at right side;

(3) G5+↑=insert;

G5+↓=cover;

G5+*=deleting the cover word;

(4) G5+GA =Num lock key for calculation or foreign money exchange;

(5) G5+G5=(1) STK (SIM TOOL KIT) mobile phone common system.

(6) G5+G6=(2) WAP (Wireless application protocol) mobile phone common system.

(7) G5+#=print;

<1>G5+#+&=print all;

<2>G5+#+#=print this page;

<3>G5+*+*+?=number of pages to be printed. ? number represents the number of pages to be printed. For example, if to print one page, then keying [G5**1]; if to print 5 pages, keying [G5**5]. If 22, keying [G5**22]

3) G6 function key

(1) G6=cursor;

(2) G6+*=copy

G6+*+*=cover;

G6+#=displacement

G6+#+#=cover

(3) G6+→=Tab key

(4) G6+↑=Shift key

(5) G6+↓=Cut.

4) OK function key

(1) OK=space bar.

(2) OK+GA=Restoring key.

(3) OK+G5=Esc key

(4) OK+1=Network connection, then disconnecting from a network.

(5) OK+OK=file storage.

(6) OK+*=actuating key.

(7) OK+#=closing key.

(8) OK+#+#=hot key for Microsoft application.

(9) OK+↓=searching the next one.

(10) OK+↑=searching for previous one.

(11) OK+−=Clear key.

5) * function key

(1) *+GA =whole type (in Chinese typewriting)

(2) *+G5=half type (in Chinese typewriting)

(3) *+1=F1.

(4) *+2=F2.

(5) *+3=F3.

(6) *+4=F4.

(7) *+5=F5.

(8) *+6=F6.

(9) *+7=F7.

(10) *+8=F8.

(11) *+9=F9.

(12) *+10=F10.

(13) *+11=F11.

(14) *+12=F12.

(15) *=multiplication operation.

6) # function key

(1) #=dividing operation.

(2) #+G5=CTRL key.

(3) #+GA=Alt key.

(4) #+OK=Delete key.

(5) #+*=Opening a new file.

(6) #+#=Opening a old file.

(7) #+G5=Storing a file in another memory space.

(8) #+G6=Change filename.

(9) #+←=drawing a line leftwards.

(10) #+→=drawing a line rearwards.

(11) #+↑=drawing a line upwards.

(12) #+↓=drawing a line downwards.

(13) #+/=drawing a line from upper right to lower left.

(14) #+\=drawing a line from upper left to lower right.

(15) #+←←=drawing a bold face line leftwards.

(16) #+→→=drawing a bold face line rearwards.

(17) #+↑↑=drawing a bold face line upwards.

(18) #+↓↓=drawing a bold face line downwards.

(19) #+//=drawing a bold face line from upper right to lower left.

(20) #+\\=drawing a bold face line from upper left to lower right.

7) +=addition operation.

8) −=subtraction operation.

9) ←=move leftwards.

10) →=move rightwards.

11) ↑=move upwards.

12) ↓=move downwards.

13) ===(an equality operation)

14) A+GA=file.

15) D+GA=compile.

16) J+GA=insertion.

17) M+GA=format.

18) P+GA=tool.

19) T+GA=table.

20) W+GA=Window.

21) *+G6=description.

22) *+OK=Internet browse.

23) *+W=WEB world wide web.

24) *+A=connection.

25) Setting of symbols.

| | |
|---|---|
| (1) G5 + 0 = . | G5 + 00 = ° |
| (2) G5 + 9 = , | G5 + 99 = ; |
| (3) G5 + 8 = [ | G5 + 88 = ] |
| (4) G5 + 7 = ( | G5 + 77 = ) |
| (5) G5 + 6 = ? | G5 + 66 = ! |
| (6) G5 + 5 = / | G5 + 55 = \ |
| (7) G5 + 4 = < | G5 + 44 = > |
| (8) G5 + 3 = { | G5 + 33 = } |
| (9) G5 + 2 = % | G5 + 22 = & |
| (10) G5 + 1 = _{—} | G5 + 11 = - |
| (11) G6 + 0 = @ | G6 + 00 = $ |
| (12) G6 + 9 = # | G6 + 99 = * |
| (13) G6 + 8 = “ | G6 + 88 = ” |
| (14) G6 + 7 = \| | G6 + 77 = ; |

2. Input instruction:

1) For English-Numerical input system:

<1> clicking GA+GA entering into Chinese input system.

<2> further clicking GA+GA entering into complex form Chinese

<3> in the complex form Chinese, further clicking GA+1=input system of the complex form Chinese handset number.

A. at most five codes is used in a single Chinese character input for the handset number, all no [repeated code]

B. at most five codes is used in a multiple Chinese character input for the handset number, all no [repeated code]

(1) Six keys for a phrase forming by two words

(2) Six keys for a phrase forming by three words

(3) Eight keys for a phrase forming by four words

(4) Ten keys for a phrase forming by five words

<4> In the complex form Chinese, further clicking GA+2=new phonetic notation input system of the complex form Chinese handset number.

(1) Six keys for a phrase forming by two words

(2) Six keys for a phrase forming by three words

(3) Four keys for a phrase forming by four words

(4) Fifth keys for a phrase forming by five words

(5) Six keys for a phrase forming by six words

(6) Seven keys for a phrase forming by seven words

(7) Eight keys for a phrase forming by eight words

(8) Nine keys for a phrase forming by nine words

(9) Ten keys for a phrase forming by ten words

<5> In the complex form Chinese, further clicking GA+3=new radical input system of the complex form Chinese handset number.

(1) Four keys for a phrase forming by two words

(2) Six keys for a phrase forming by three words

(3) Four keys for a phrase forming by four words

(4) Fifth keys for a phrase forming by five words

(5) Six keys for a phrase forming by six words

(6) Seven keys for a phrase forming by seven words

(7) Eight keys for a phrase forming by eight words

(8) Nine keys for a phrase forming by nine words

(9) Ten keys for a phrase forming by ten words

2) In the English-Number input system

<1> clicking GA+G6 entering into simple form Chinese input system. In the simple form Chinese, further clicking GA+1=input system of the simple form Chinese handset number.

A. at most five codes is used in a single Chinese character input for the handset number, all no [repeated code]

B. at most five codes is used in a multiple Chinese character input for the handset number, all no [repeated code]

(1) Six keys for a phrase forming by two words

(2) Six keys for a phrase forming by three words

(3) Eight keys for a phrase forming by four words

(4) Ten keys for a phrase forming by five words

<2> In the simple form Chinese, further clicking GA+2=new phonetic notation input system of the simple form Chinese handset number.

(1) Six keys for a phrase forming by two words

(2) Six keys for a phrase forming by three words

(3) Four keys for a phrase forming by four words

(4) Fifth keys for a phrase forming by five words

(5) Six keys for a phrase forming by six words

(6) Seven keys for a phrase forming by seven words

(7) Eight keys for a phrase forming by eight words

(8) Nine keys for a phrase forming by nine words

(9) Ten keys for a phrase forming by ten words

3) For English-Numerical input system:

<1> Clicking GA+G5 entering into Korean input system.

<2> Further clicking G5+GA entering into Korean handset input code.

<3> Further clicking G5+G6 entering into Korean 64 keys input code.

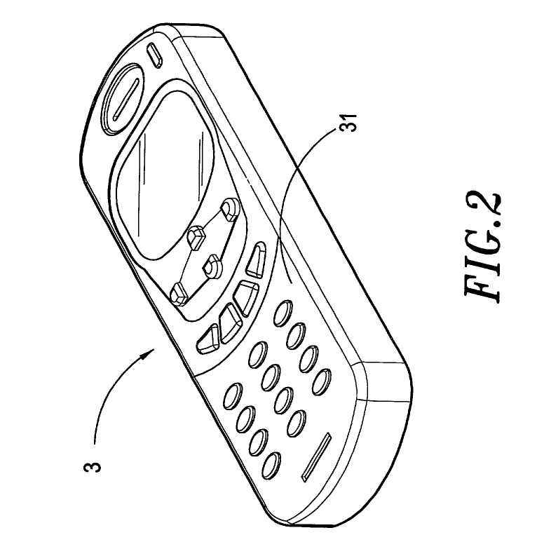

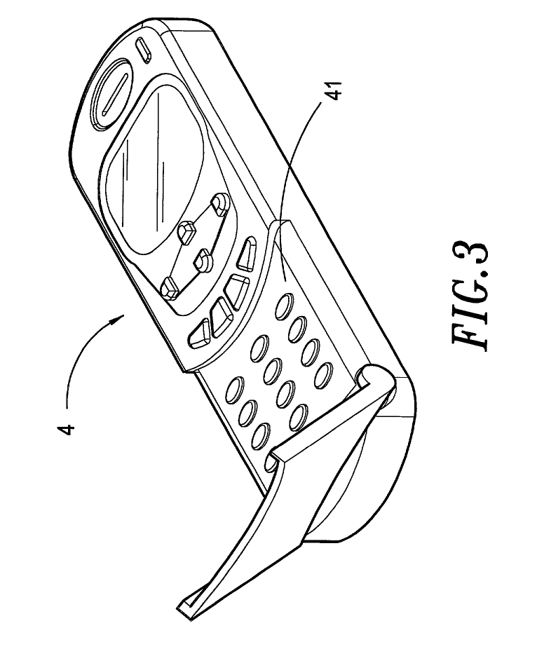

Now referring to FIGS. 2 to 3, it is shown that the present invention is used with a handset. If it is appreciated from the drawing that the interface of the present invention can be used with various handsets (3, 4). It is only necessary that the number of keys in the panel must be more than the general used handset. However, handsets with the interface of the present invention (3, 4) may be used to support the text processing for various languages. As comparing with other prior arts, the present invention has the following advantages:

1. For the setting of handset type computers and handset interfaces of the present invention, four special function keys [GA, G5, G6, OK] (11, 12, 13, 14) and [← ↑ ↓ → + − =] (15, 16, 17, 18, 19, 20, 21) are used, people all over the world can use the present invention to process texts of various languages.

2. In the setting of handset type computers and handset interfaces of the present invention, all settings about various nations are embodied in a chipset so as to be updated according to the language of the used text.

3. The setting of handset type computers and handset interfaces of the present invention has the function of e-mail, exchange rate conversion, calculator, translation, multimedia, receiving network program, etc.

4. In the setting of handset type computers and handset interfaces of the present invention, the handset code technology is used so that complex and simple form Chinese are used. No repeated code occurs.

5. In the setting of handset type computers and handset interfaces of the present invention, a compact size handset is used so that the effect of text processing is developed.

6. In the setting of handset type computers and handset interfaces of the present invention, handsets from various manufactures can be used and the original function can be retained.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for setting keys of handset type computers and handset interfaces, wherein four special function keys [GA, G5, G6, OK] and [← ↑ ↓ → + − =] are used in the setting interface of various languages, the interface is used in various handsets so that each the handset has the function of text processing.

2. The method for setting keys of handset type computers and handset interfaces as claimed in claim 1, wherein the setting interface is built in a chipset and then the chipset is installed in a handset.
